(19) United States
(12) Patent Application Publication
(10) Pub. No.: US 2018/0052917 A1
(43) Pub. Date: Feb. 22, 2018

(54) COMPUTER-IMPLEMENTED METHODS AND SYSTEMS FOR CATEGORIZATION AND ANALYSIS OF DOCUMENTS AND RECORDS

(71) Applicants: Keith Thompson, Ann Arbor, MI (US); Mark Alexander, Ann Arbor, MI (US); Kunal Joshi, Ann Arbor, MI (US); Benjamin P. King, Ann Arbor, MI (US); James Lee, Ann Arbor, MI (US); Vikram Parvathaneni, Ann Arbor, MI (US); Nandit Soparkar, Ann Arbor, MI (US); Jayadevan Vadake-kottattil, Ann Arbor, MI (US)

(72) Inventors: Keith Thompson, Ann Arbor, MI (US); Mark Alexander, Ann Arbor, MI (US); Kunal Joshi, Ann Arbor, MI (US); Benjamin P. King, Ann Arbor, MI (US); James Lee, Ann Arbor, MI (US); Vikram Parvathaneni, Ann Arbor, MI (US); Nandit Soparkar, Ann Arbor, MI (US); Jayadevan Vadake-kottattil, Ann Arbor, MI (US)

(21) Appl. No.: 15/679,712

(22) Filed: Aug. 17, 2017

Related U.S. Application Data
(60) Provisional application No. 62/376,368, filed on Aug. 17, 2016.
(60) Provisional application No. 62/376,374, filed on Aug. 17, 2016.

(51) Int. Cl. G06F 17/30; G06F 17/27

(52) U.S. Cl. CPC G06F 17/30705; G06F 17/30011; G06F 17/2785

(57) ABSTRACT

Computer-implemented methods and systems are disclosed for categorizing and analyzing documents and records using combinations of concept elements selected from a set of semantically coherent dimensions. Each combination of concept elements is a tuple, which is a sequence or a set of elements selected from the dimensions.

### CROSS REFERENCE TO RELATED APPLICATIONS

This application claims priority from U.S. Provisional Patent Application No. 62/376,368 filed on Aug. 17, 2016 entitled UNIVERSAL CODING WITH TUPLES and U.S. Provisional Patent Application No. 62/376,374 filed on Aug. 17, 2016 entitled SEMANTIC N-GRAM INDEXES, both of which are hereby incorporated herein by reference.

### BACKGROUND

The present application relates generally to the categorization and analysis of documents and records including, e.g., insurance claims, warranty claims, patient charts, and vehicle repair records.

For many useful applications, associating metadata with documents and/or records is necessary and important. However, current techniques for such associated metadata have several technical problems. Below, we describe some applications and their associated metadata, we identify shortcomings that we address, and our technological solutions that help to address the shortcomings. Our description is organized into discussions related to metadata for documents (paragraphs Ia-d, IIa-b, and Ma) and records (paragraphs Ip-s, IIp-r, and IIIp)

Ia: Indexing individual documents is an important aspect of search and retrieval technology. Usually, criteria that apply to contents of the document to be indexed are used to determine the appropriate index terms to associate with the document. Sometimes, such indexing criteria apply to multiple documents that are related in some way.

Ib: Often, but not always, an index term is used to summarize succinctly some aspect of the contents of a document. When used in this manner and taken together, all the associated index terms may then summarize succinctly all the contents of a document.

Ic: The index terms used are usually drawn from a vocabulary or a taxonomy of commonly well-known semantic elements (e.g., from a dictionary). More generally, individual index terms are drawn from the concept elements within an ontology that is applicable to the domain(s) of discourse that pertain to the documents being indexed.

Id: There are several examples of ontologies linked from the references provided below, and for our purposes, an example ontology includes SNOMED for the healthcare domain. Healthcare or medical documents may be indexed using concept elements drawn from SNOMED, and those index terms would reflect the contents of the documents. As another example, for vehicle repairs, we may envisage an ontology with various concept elements pertaining to vehicles and their repairs.

Ip: Categorizing individual records from a set is an important business activity. Such categorization includes efforts colloquially called “sorting” or “binning”. Usually, some criteria are used to determine the appropriate category for each record. Such categorization criteria may be known explicitly, implicitly, or be partly explicit or implicit. Sometimes, the criteria apply to multiple records that are related in some way.

Iq: For some uses, each record may be categorized into multiple categorization groups. Each categorization group may have its own categorization criteria. Therefore, a single record may be categorized into a category within each such group. As such, each categorization group may be regarded as a single instance of categorization described in paragraph Ip above.

Ir: To categorize a record, a “code” may be assigned to each record. Each code represents a category as described in paragraph Ip above. As such, the categorization is called “coding”, and processed records are said to be “coded”. For some uses, each record may be coded into multiple codes groups. A code group is a categorization group as described in paragraph Iq above.

Is: For certain uses, several categories from a given categorization group may apply to the same individual record. This contrasts with the categorization as described in paragraph Ip above, but the remaining discussions from paragraphs Iq-Ir still apply. Often a code is used to summarize succinctly some aspects of the contents of a record. When considered together, and if multiple codes are assigned to a record, all assigned codes may then together summarize succinctly all contents of the record.

IIa: The indexing and the ontologies mentioned above are widely used, but they lack certain desirable properties. Ideally, the ontologies should be very comprehensive in order to enable indexing documents to an arbitrary degree of semantic specificity. One reason is that such detail and specificity enables superior search and retrieval. However, creating comprehensive ontologies is an expensive proposition, and seldom undertaken without expending significant financial, time and human resources. Furthermore, even with very comprehensive ontologies, capturing the many different semantic concepts represented in an arbitrary document is not realistically possible if those semantics need to be reflected as concept elements in the ontologies. For example, the concept elements “air-conditioner”, “not blowing”, and “while accelerating” may each be present in a vehicle repairs ontology. However, that ontology may not have a specific concept element to represent a situation described in a document for the air-conditioner not blowing when the vehicle accelerates. Adding another concept element that represents this particular situation may be possible, but there would be a virtually infinite set of such new concepts to add to the example vehicle repairs ontology. In fact, the document contents, in terms of its sentences, paragraphs etc., may be regarded as a means to represent more complex concepts (i.e., than those present as concept elements in an associated particular ontology).

### BRIEF SUMMARY OF THE DISCLOSURE

In accordance with one or more embodiments, a computer implemented method of automatically categorizing a record is disclosed. The method features the steps, performed by a computer system, of: (a) storing a set of predefined dimensions, each dimension including a plurality of hierarchically organized concept elements semantically related to one another; (b) receiving, at the computer system, information on the record to be categorized; (c) determining, by the computer system, a single concept element for at least two of said dimensions based on the information in the record to form a set of semantically coherent concept elements indicative of the information in the record; (d) specifying a code comprising a tuple combination of the concept elements determined in (c), and associating the code with the record; and (e) outputting the code for the record.

In accordance with one or more embodiments, a method of analyzing a plurality of records is provided. Each record is categorized by one or more tuple combinations of concept elements, using a graphical user interface and a user input device of a computer system, comprising the steps of: (a) displaying on the graphical user interface a plurality of predefined dimensions and a plurality of hierarchically organized concept elements semantically related to one another for each said dimension; (b) receiving a selection in the graphical user interface of a single concept element in each of a plurality of said dimensions by the user using the user input device; (c) specifying a code comprising a tuple combination of the concept elements selected by the user; (d) identifying each record categorized by the code; and (e) displaying information on each record identified in (d) to the user.

In accordance with one or more further embodiments, a method of categorizing a record is provided using a graphical user interface and a user input device of a computer system, comprising the steps of: (a) displaying in the graphical user interface a plurality of predefined dimensions and a plurality of hierarchically organized concept elements semantically related to one another for each dimension; (b) receiving a selection in the graphical user interface of a single concept element in each of a plurality of said dimensions by the user using the user input device based on information in the record; and (c) specifying a code comprising a tuple combination of the concept elements selected by the user, and associating the code with the record.

A computer system in accordance with one or more embodiments comprises at least one processor; memory associated with the at least one processor storing a set of predefined dimensions, each dimension including a plurality of hierarchically organized concept elements semantically related to one another; a display; computer input and output devices; and a program supported in the memory for categorizing a record. The program contains a plurality of instructions which, when executed by the at least one processor, cause the at least one processor to: (a) receive information on the record; (b) determine a single concept element for at least two of said dimensions based on the information in the record to form a set of semantically coherent concept elements indicative of the information in the record; (c) specify a code comprising a tuple combination of the concept elements determined in (b), and associate the code with the record; and (d) output the code for the record.

### BRIEF DESCRIPTION OF THE DRAWINGS

FIG. 1 is a screenshot with an exemplary graphical user interface used for analyzing records categorized in accordance with one or more embodiments.

FIG. 2 illustrates an exemplary sentence that has been grammatically parsed.

FIG. 3 is a screenshot with an exemplary graphical user interface used for analyzing records categorized in accordance with one or more embodiments to exemplify the dimension elements that help constitute a particular assigned code.

FIG. 4 is a screenshot with an exemplary graphical user interface used for analyzing records categorized in accordance with one or more embodiments to exemplify a particular record and its particular assigned code.

FIG. 5 is a block diagram illustrating an exemplary computer system used for categorization and analysis of documents and records in accordance with one or more embodiments.

### DETAILED DESCRIPTION

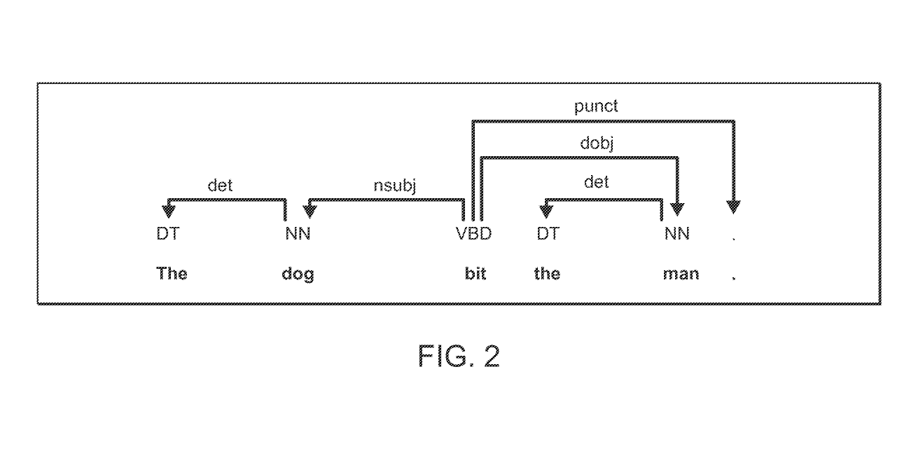

IIb: Various embodiments disclosed herein relate to categorization techniques that address the difficulty of having to include too many explicitly defined concept elements in an ontology, and yet allow for arbitrarily detailed semantic index terms. Given a domain of discourse, we allow index terms to be formed as a tuple combination of concept elements drawn from the ontology used for that domain of discourse. That is, such index terms themselves are implicitly defined as tuples, consisting of concepts drawn from the appropriate semantically coherent portions of the ontology to be used etc. Implicitly defining index terms by tuples reduces the number of concept elements needed to be defined explicitly, while still allowing for capturing significant, perhaps arbitrary, detail and specificity. While previous indexing methods allow the indexing multiple words together as “n-grams”, the elements of such an n-gram are formed from contiguous words in the text. In accordance with one or more embodiments, the elements of the tuple can be concept elements from an ontology, and the words need not appear directly in the text, nor be contiguous. For example, if using a grammatical parser as in FIG. 2, it is possible to identify the subject, main verb, and direct object of a sentence. These three elements could then be put together in a tuple that represents the semantics of the sentence. Also, note that we can specify how the tuple elements should relate to one another, but we leave such specification to the broader context of indexing use.

IIp: “Medical codes” exemplify an important business use for codes. Often in such coding, several code groups are applicable to each record. Also, multiple codes from a single code group may apply to each record. Common code groups include ICD10, CPT, HCPCS etc. Typically, records generated at a healthcare provider are coded, and then submitted for insurance reimbursement.

IIq: Vehicle “warranty codes” exemplify another business use for codes. Often in such coding, several code groups are applicable to each record. In addition, multiple codes from a single code group may apply to each record. Repair records created at a vehicle repair location are coded in this manner, and coded records are usually submitted to manufacturers for warranty reimbursement.

IIr: The codes described in paragraphs IIp and IIq above are widely used, but the number and the organization of the codes lack certain desirable properties. For instance, the number of CPT codes exceeds 10,000, and the lack of structure among codes makes manual code-assignment, organization, and analysis the coded records very difficult. Of course, provision of detailed codes enables capturing greater detail and variety of the record contents. Also, usually these codes have been defined at certain specific levels of detail, but often the contents of a record do not provide sufficient amount of information to code it at that level of detail. For instance, a vehicle repair record may state “Car check-engine light comes on”, whereas the available codes may include only “Check-engine light turns on intermittently” or “Check-engine light stays on throughout”. In this example, neither of the codes is quite appropriate for the content of the record. Similarly, there may be more detailed information available in the contents of a record than can be captured by the available codes. Altering the previous example, suppose that a vehicle repair record states “Check-engine light turns on intermittently”, but the codes only include the less detailed “Check-engine light comes on”. For this example, the available code does not capture the more detailed information on intermittence stated in the record.

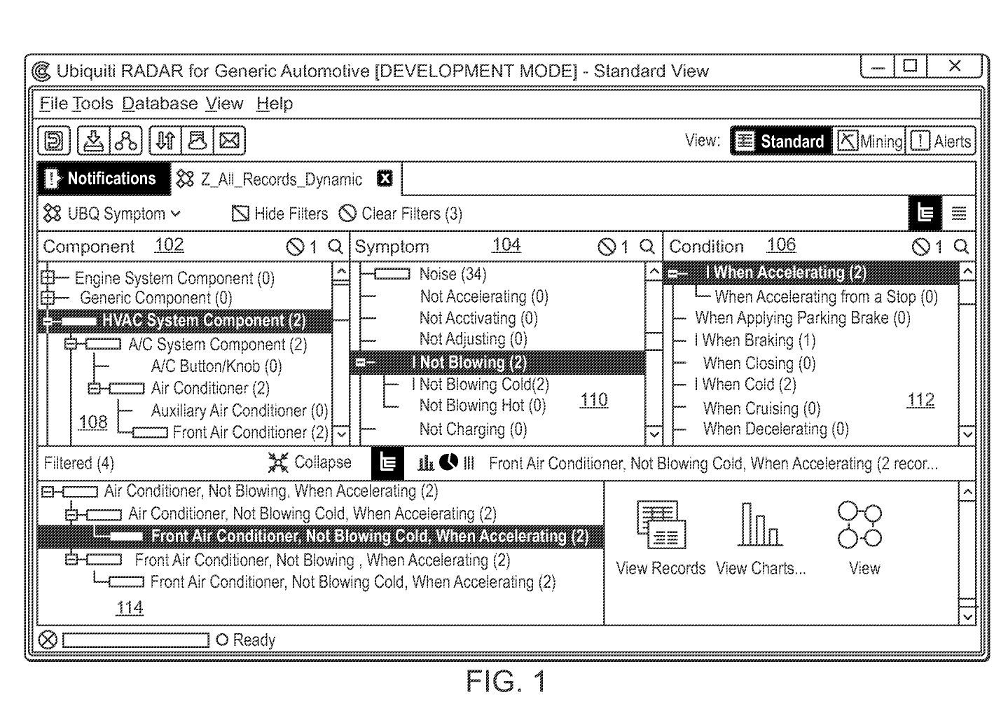

IIIa: FIG. 1 is an exemplary screenshot illustrating a graphical user interface for analysis of records coded in accordance with one or more embodiments. For “UBQ Symptom” index terms (for documents) or codes (for records) pertaining to vehicle repairs, we used three semantically coherent portions of a vehicle repairs ontology (or equivalently, three semantic categorization dimensions). The figure shows “Component”, “Symptom” and “Condition” elements or dimensions 102, 104, 106 (i.e., to reflect the description of a vehicle repair, for the involved component, the symptom observed, and the vehicle state, respectively). Each semantically coherent portion (or dimension) is organized hierarchically into concept elements 108, 110, 112. The specific UBQ Symptom index terms (or codes) are tuple combinations of the concept elements 108, 110, 112 with the tuple elements drawn from semantically coherent parts (or dimensions), and such tuple combinations are shown in the lower frame 114 of the figure. Note that UBQ Symptom tuples are organized and may be navigated with the hierarchical structure of each semantically coherent part (or dimension), which approach also enables filtering of documents or records. Also note that UBQ Symptom tuples need not be defined explicitly, and instead, the constituent elements of the tuples help to define them implicitly.

IIIp: Various embodiments disclosed herein for codes help to address the two shortcomings of having too many explicitly defined codes, and poor organization for the codes. For a given domain of discourse, we define several dimensions, each with a semantically coherent set of concepts that are hierarchically organized from general concepts down to the specific. The codes themselves are implicitly defined as tuples, consisting of concepts drawn from the defined semantically coherent dimensions. Allowing for codes to contain concepts from any level of the dimensions also allows for arbitrary levels of detail to be captured, since the dimensions can be defined to arbitrary levels of detail. Implicitly defining codes by tuples reduces the number of tuples to be defined, while still allowing for capturing of great detail and variety. Additionally, the hierarchical organization of the constituent dimensions of the tuples provides a means for organizing the codes themselves, thereby also providing a better means to analyze the coded records.

In one or more exemplary embodiments, a computer system uses natural language processing (NLP) techniques to automatically categorize a record as follows: (a) Using any appropriate NLP technique(s), the text in a record is read by software, and groups of proximally-located words are identified and matched with appropriate concept elements from the applicable dimensions. (b) Again using any appropriate NLP technique(s), the concept elements from the dimensions are combined to form the associated code to be assigned to the record. The concept elements from the dimensions may be combined based on their proximal positions as related to the text in the record.

As a non-limiting example, the computer system passes text through a standard grammatical parser such as, e.g., the Stanford Parser (http://nlp.stanford.edu:8080/parser/), which automatically groups words into grammatical constituents and labels the dependencies between them. Using either machine learning or a rule-based system, the system uses the produced parse trees to identify which of the relevant dimensions are applicable to the text and which of the constituents might get associated with those dimensions. This process could also be performed simply by splitting the text into n-grams, consisting of consecutive words in the text (https://en.wikipedia.org/wiki/N-gram), and applying a series of known rules to identify n-grams of various lengths that may correspond to certain dimensions. For example, one simplistic rule may state that an n-gram starting with “WHEN” should be considered as a candidate for the Condition dimension. It should be understood that many different NLP techniques could be used for this step, and the particular method used here is not material to our innovation.

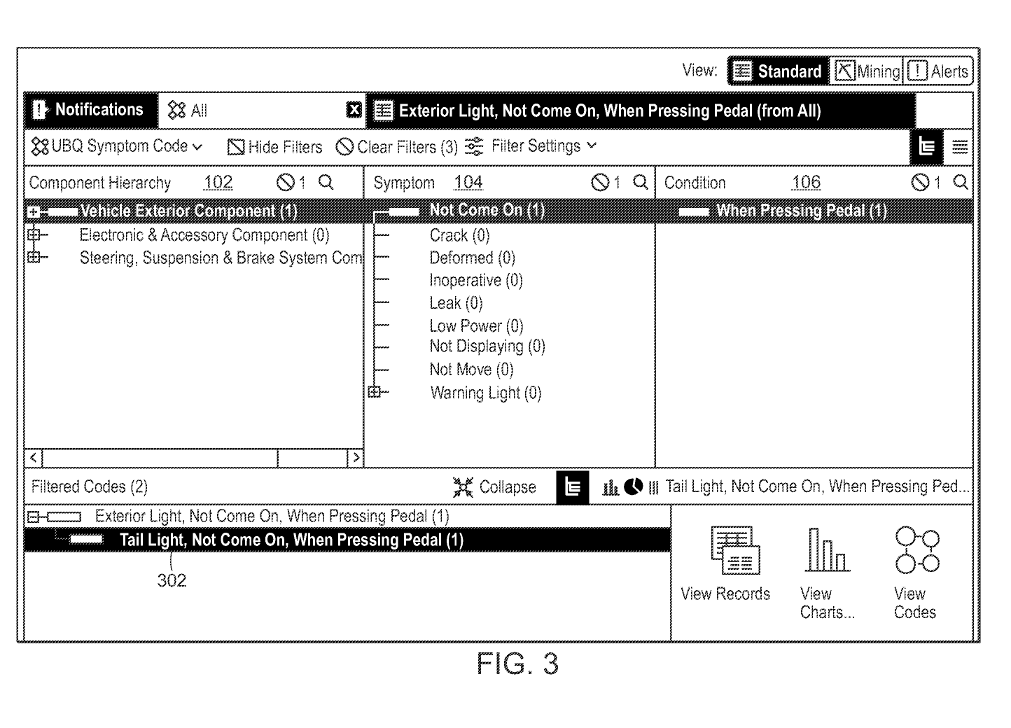

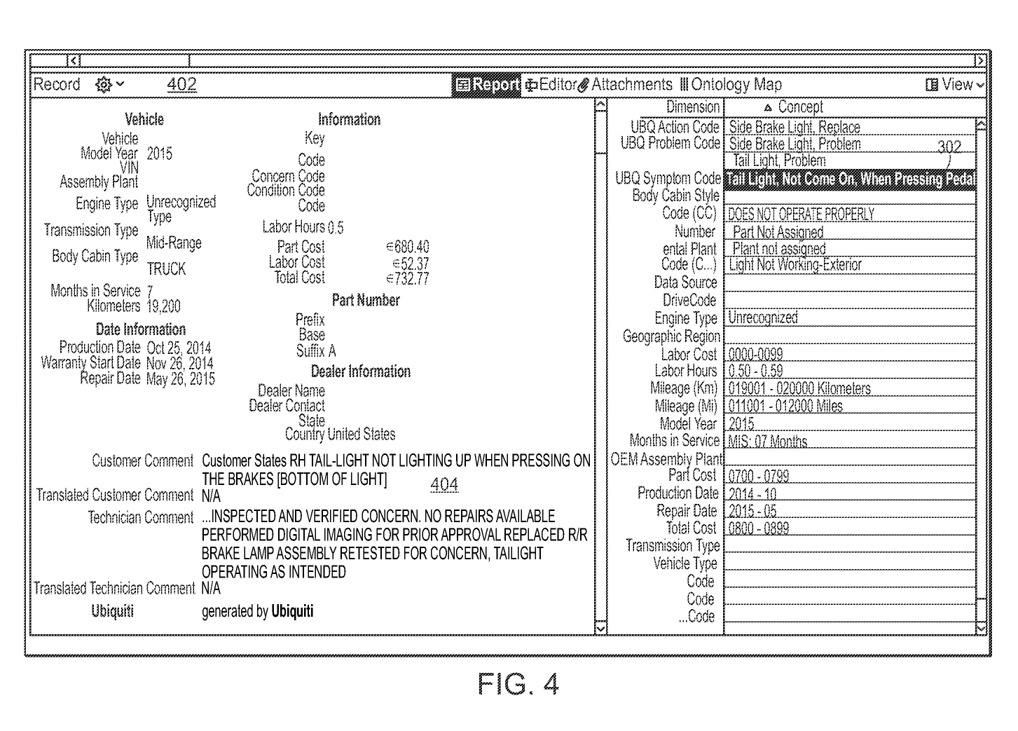

The exemplary screenshots of FIGS. 3 and 4 further illustrate this process. FIG. 3 shows the selection of a particular record by navigating the constituent dimensions 102, 104, 106 for a Symptom Code 302. FIG. 4 shows an identified record 402 (with some redactions) containing text 404, and the code 302 (on the right) derived from the text 404. The text 404 has three sets of proximally-located words, which are “RH TAIL-LIGHT”, “NOT LIGHTING UP”, and “WHEN PRESSING ON THE BRAKES.” These sets of words are identified with “Tail Light” (from the Component Hierarchy dimension 102), “Not Come On” (from the Symptom dimension 104), and “When Pressing Pedal” (from the Condition dimension 106). Thereafter, and since the dimension elements identified are positioned proximally as related to the text on the left, the dimension elements would be combined to form the Symptom Code 302 (Tail Light, Not Come On, When Pressing Pedal).

In accordance with one or more embodiments, a user can manually code records using a graphical user interface similar to that shown in FIG. 1 in a computer system. Using the graphical user interface, the user can select a single concept element in each of the dimensions. The computer system will then specify a code comprising a tuple combination of the concept elements selected by the user, and associate the code with the record.

The categorization methods in accordance with various embodiments can have a variety of applications in addition to categorizing repair records and medical records. Other possible applications can include, but are not limited to, (a) coding text data for Qualitative Data Analysis (QDA), (b) describing various situations in virtually any industry (e.g., problems, conditions, studies etc.) based on available international and other code standards, and (c) improving the organization of existing coding schemes that use a combination of elements drawn from multiple dimensions (where, unlike the case for various embodiments, each dimension is not semantically coherent, and nor are the multiple dimensions consistent among one another).

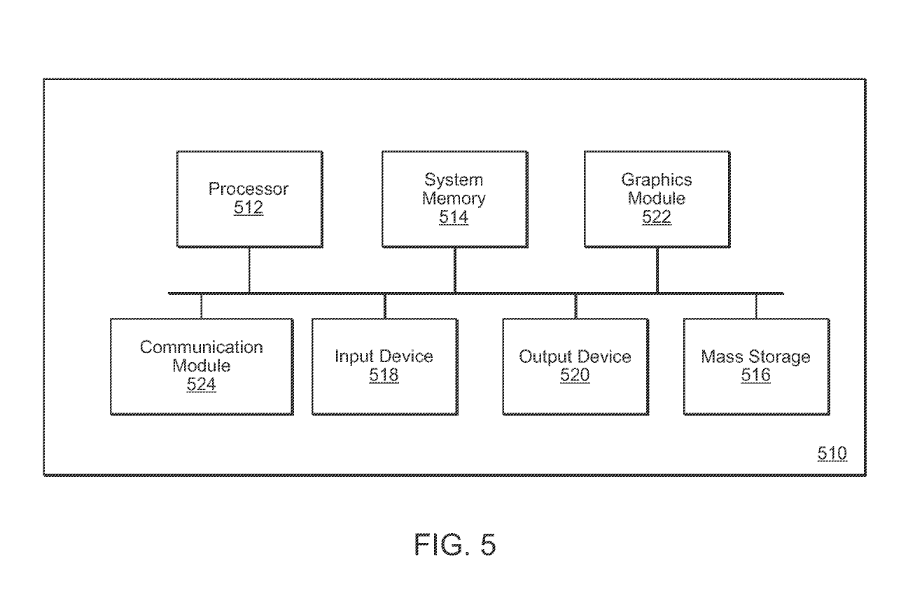

The methods, operations, modules, and systems described herein may be implemented in one or more computer programs executing on a programmable computer system. FIG. 5 is a simplified block diagram illustrating an exemplary computer system 510, on which the computer programs may operate as a set of computer instructions. The computer system 510 includes at least one computer processor 512, system memory 514 (including a random access memory and a read-only memory) readable by the processor 512. The computer system also includes a mass storage device 516 (e.g., a hard disk drive, a solid-state storage device, an optical disk device, etc.). The computer processor 512 is capable of processing instructions stored in the system memory or mass storage device. The computer system additionally includes input/output devices 518, 520 (a keyboard, pointer device, display, etc.), a graphics module 522 for generating graphical objects, and a communication module or network interface 524, which manages communication with other devices via telecommunications and other networks.

Each computer program can be a set of instructions or program code in a code module resident in the random access memory of the computer system. Until required by the computer system, the set of instructions may be stored in the mass storage device or on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer system may comprise one or more physical machines, or virtual machines running on one or more physical machines. In addition, the computer system may comprise a cluster of computers or numerous distributed computers that are connected by the Internet or another network.

Accordingly, the foregoing description and attached drawings are by way of example only, and are not intended to be limiting.

What is claimed is:

1. A computer implemented method of automatically categorizing a record comprising the steps, performed by a computer system, of:
(a) storing a set of predefined dimensions, each dimension including a plurality of hierarchically organized concept elements semantically related to one another;
(b) receiving, at the computer system, information on the record to be categorized;
(c) determining, by the computer system, a single concept element for at least two of said dimensions based on the information in the record to form a set of semantically coherent concept elements indicative of the information in the record;
(d) specifying a code comprising a tuple combination of the concept elements determined in (c), and associating the code with the record; and
(e) outputting the code for the record.

2. The method of claim 1, wherein the record comprises an activity record.

3. The method of claim 2, wherein the activity record comprises a repair record or a medical record.

4. The method of claim 1, wherein the record comprises text data to be coded for qualitative data analysis.

5. The method of claim 1, wherein the record comprises a repair record, and the dimensions comprise a component dimension, a symptom, defect, or action dimension, and/or a condition dimension.

6. The method of claim 1, wherein the record comprises a medical record, and the dimensions comprise an anatomical body part dimension, a symptom, problem, or action dimension, and a condition dimension.

7. The method of claim 1, further comprising repeating (c) and (d) one or more times to categorize the record with a plurality of codes.

8. The method of claim 1, wherein (c) is performed using natural language processing.

9. A method of analyzing a plurality of records, each categorized by one or more tuple combinations of concept elements, using a graphical user interface and a user input device of a computer system, comprising the steps of:
(a) displaying on the graphical user interface a plurality of predefined dimensions and a plurality of hierarchically organized concept elements semantically related to one another for each said dimension;
(b) receiving a selection in the graphical user interface of a single concept element in each of a plurality of said dimensions by the user using the user input device;
(c) specifying a code comprising a tuple combination of the concept elements selected by the user;
(d) identifying each record categorized by the code; and
(e) displaying information on each record identified in (d) to the user.

10. The method of claim 9, wherein the concept elements are displayed in a drop-down menu or list box for each dimension in the graphical user interface.

11. The method of claim 9, wherein the concept elements are organized in a tree structure for each dimension in the graphical user interface.

12. The method of claim 9, wherein the records comprises activity records.

13. The method of claim 12, wherein the activity records comprises repair records or medical records.

14. The method of claim 9, wherein the records comprises text data coded for qualitative data analysis.

15. The method of claim 9, wherein the records comprises repair records, and the dimensions comprise a component dimension, a symptom, defect, or action dimension, and a condition dimension.

16. The method of claim 9, wherein the records comprise medical records, and the dimensions comprise an anatomical body part dimension, a symptom, problem, or action dimension, and a condition dimension.

17. A method of categorizing a record using a graphical user interface and a user input device of a computer system, comprising the steps of:
(a) displaying in the graphical user interface a plurality of predefined dimensions and a plurality of hierarchically organized concept elements semantically related to one another for each dimension;
(b) receiving a selection in the graphical user interface of a single concept element in each of a plurality of said dimensions by the user using the user input device based on information in the record; and
(c) specifying a code comprising a tuple combination of the concept elements selected by the user, and associating the code with the record.

18. The method of claim 17, wherein the concept elements are displayed in a drop-down menu or list box for each dimension in the graphical user interface.

19. The method of claim 17, wherein the concept elements are organized in a tree structure for each dimension in the graphical user interface.

20. The method of claim 17, wherein the record comprises an activity record.

21. The method of claim 20, wherein the activity record comprises a repair record or a medical record.

22. The method of claim 17, wherein the record comprises text data to be coded for qualitative data analysis.

23. The method of claim 17, wherein the record comprises a repair record, and the dimensions comprise a component dimension, a symptom, defect, or action dimension, and a condition dimension.

24. The method of claim 17, wherein the record comprises a medical record, and the dimensions comprise an anatomical body part dimension, a symptom, problem, or action dimension, and a condition dimension.

25. The method of claim 17, further comprising repeating (b) and (c) one or more times to categorize the record with a plurality of codes.

26. A computer system, comprising:
at least one processor;
memory associated with the at least one processor storing a set of predefined dimensions, each dimension including a plurality of hierarchically organized concept elements semantically related to one another;
a display;
computer input and output devices; and
a program supported in the memory for categorizing a record, the program containing a plurality of instructions which, when executed by the at least one processor, cause the at least one processor to:
(a) receive information on the record;
(b) determine a single concept element for at least two of said dimensions based on the information in the record to form a set of semantically coherent concept elements indicative of the information in the record;
(c) specify a code comprising a tuple combination of the concept elements determined in (b), and associate the code with the record; and
(d) output the code for the record.
